(19) United States
(12) Patent Application Publication
(10) Pub. No.: US 2013/0031833 A1
(43) Pub. Date: Feb. 7, 2013

(54) MODULAR, PRE-VEGETATED RECYCLED CARDBOARD BOX SYSTEM FOR GREEN ROOF APPLICATIONS

(71) Applicant: Janet L. MacKinnon, The Sea Ranch, CA (US)

(72) Inventor: Janet L. MacKinnon, The Sea Ranch, CA (US)

(21) Appl. No.: 13/197,271

(22) Filed: Aug. 3, 2011

(51) Int. Cl. A01G 9/02

(52) U.S. Cl. 47/65.6

(57) ABSTRACT

Embodiments are described for a cardboard box assembly for use in a modular green roof system. The box includes a drainage board, filter and pre-vegetated growing media. A lid assembly is placed over the box during transport and storage. The box/lid assembly is designed to be stackable for easy transport on pallets for placement in an interlocking array on a roof or similar surface. The box is made of biodegradable cardboard allows for the eventual breakdown of the container portion of the assembly and the formation of an integrated green roof of interlocking plants after a period of time after installation. The filter fabric sock wrapping the box bottom, sides and fitted top provides the enclosure that will hold the pre-vegetated modular components together when the cardboard box eventually biodegrades.

### FIELD OF THE INVENTION

One or more implementations relate generally to green roof planters, and more specifically to modular, recycled cardboard box structures for transporting and deploying pre-vegetated plant trays on building roofs.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The move toward green buildings that incorporate sustainable materials and features has led to the increased adoption of green roofs in which planters are placed on wide expanses of under-utilized roof and balcony spaces of large buildings. Current green roof products are typically based on simple plastic planters that are placed on flat roofs and building surfaces. Although these planters ostensibly help incorporate green concepts in housing, the planter material is itself not sustainable, in that it based on plastic and other non-ecologically friendly materials.

There are presently two different deployment methods utilized in the green roof industry. The first is the field-applied (planted-in-place) method in which a supersac of growing media (engineered soil), drain board and any necessary filters is placed on a roof. These are typically large bundles of material that are hoisted up onto the roof of a building using cranes or similar heavy-duty equipment. The materials are placed on the roof in sequence in order to grow plants through the use of growth of seeds, seedlings, plugs, or grown plants. The second method is the pre-vegetated planter system in which planters (typically made of plastic and sometimes biodegradable material) are pre-filled with growing media and vegetation (seeds or seedlings) and then placed on a roof. This system requires the placement of the planters on a drainboard on the surface of the roof.

A major disadvantage associated with present green roof products is the transportation and installation of typical green roof planters, soil, and plant material. In general, either the field-installed or pre-vegetated tray method requires the transport and installation of the pre-vegetated plastic planters, along with the necessary irrigation and drainage support systems. This imposes significant cost and time burdens on a green roof project. In a typical, large-building application, the transport and installations requirements can necessitate the use of expensive heavy-duty equipment such as forklifts and cranes to place trays onto the roofs of the buildings. In some cases, trays and substrate/plant carriers may be designed to be individually transported and installed into the building application. Such trays, however, are generally not designed to be transported and installed as part of an overall roof planting system. Such trays are also not designed to incorporate drainage and/or irrigation functionality. For large-scale applications, such as commercial applications, this disadvantage with respect to packaging and integration can add significant cost and energy usage. The planters used in present green roof applications also restrict the growth of the plants to the extent of the planters themselves. This results in the roof box plants as being confined to there individual planters, and prevents them from integrating with each other and becoming a truly integrated living system on the building.

What is needed therefore, is a green roof planting system that facilitates the efficient transport and installation of planter trays in large-scale products, and that utilizes sustainable material and irrigation/drainage technologies to maximize the sustainable goals of green roof systems.

### BRIEF SUMMARY

Embodiments are generally directed to a modular, pre-vegetated, plant growing box system for the transport and installation of plants in green roof applications. The green roof system comprises a plurality of recycled cardboard boxes, each of which includes a drainage board placed over a bottom section with openings for water drainage. A recycled filter fabric encases the box and provides a final cover for the plant roots to embed into once the cardboard has bio-degraded. A quantity of engineered growing media is placed over the drainage board, and is pre-vegetated with seeds and/or seedlings (known as “plugs”). The boxes are designed to be stackable for easy transport on pallets, and are also designed to be placed side-by-side when deployed in an array on the surface of a roof or other building surface. Each box also includes fitted lid that is configurable to a specific height to provide a defined area of space above the growing media or plants during transport of the boxes. The box and box lids are tabbed for interlocking during transport and deployment on the building. The boxes and lids are made of recycled cardboard or similar biodegradable paper material to allow the formation of an integrated green roof of interlocking plants after a period of time after installation. The green roof system described herein combines the advantageous features of the field-applied and pre-vegetated approaches by incorporating drainage and irrigation systems in a biodegradable, recycled box system that can be transported and installed as a set of modular components.

Any of the embodiments described herein may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is a perspective view of a recycled cardboard box of the green roof planter system, under an embodiment.

FIG. 2 is a side view illustrating the components of a recycled cardboard box of the green roof planter system, under an embodiment.

FIG. 3A illustrates a green roof box with a filter fabric drainage enclosure, under an embodiment.

FIG. 3B illustrates the encapsulated green box of FIG. 3A as filled with growing media and plants.

FIG. 3C illustrates the encapsulated green box of FIG. 3B with an integrated irrigation system, under an embodiment.

FIG. 4A illustrates a filter fabric cap that can be used in conjunction with the box in a green roof system, under an embodiment.

FIG. 4B illustrates a green roof box with a fabric cap and growing plants placed in an array, under an embodiment.

FIG. 5 illustrates a green roof box and lid, under an embodiment.

FIG. 6 illustrates the green roof box and lid of FIG. 5 with the lid fitted over the box.

FIG. 7 illustrates a green roof box with a filter fabric drainage enclosure, under an embodiment.

FIG. 8 illustrates the installation of a green roof system on a roof, under an embodiment.

FIG. 9 illustrates a green roof box system incorporating an irrigation subsystem, under an embodiment.

### DETAILED DESCRIPTION

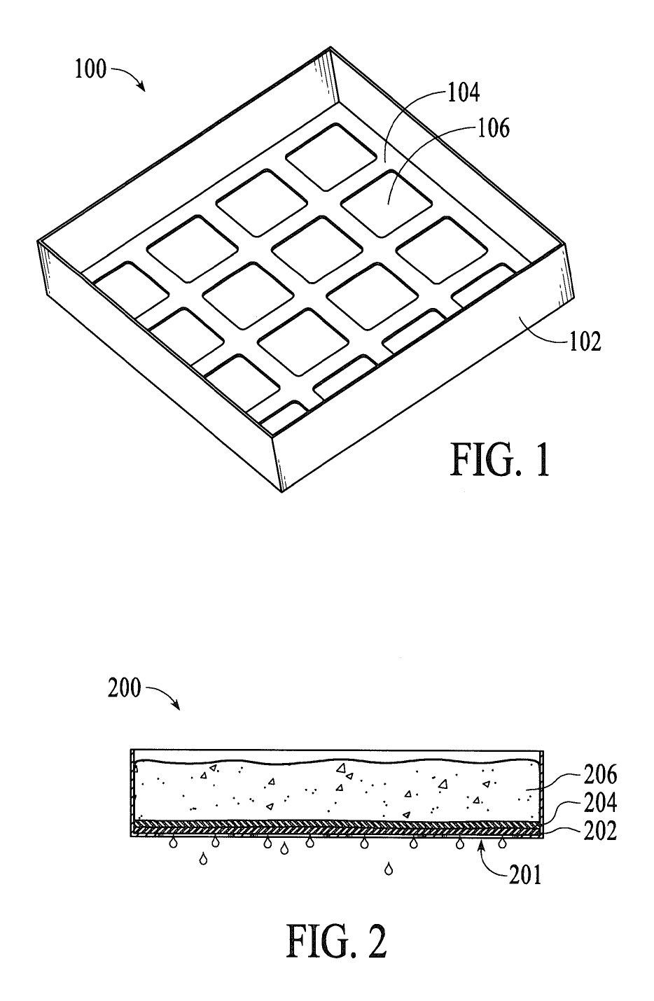

Systems and methods are described for modular, pre-vegetated green roof planters made of sustainable material. In an embodiment, the green roof planter system comprises a recycled cardboard box that holds a recycled polypropylene drain board. The cardboard box is filled with growing media as a “soil” for plants, such as flowers, shrubs, herbs, vegetables, and other suitable plants. FIG. 1 is a perspective view of a cardboard box of the green roof planter system, under an embodiment. The cardboard box 100 of FIG. 1 includes four sides 102 and a bottom section 104, which has a plurality of openings 106 formed therein. In an embodiment, the box 100 is a square box of dimension 16 inches long by sixteen inches wide (16″×16″) and a height of three to four inches tall. The openings 106 acts as drain holes to allow water to flow through when the plants and grow media are irrigated. For the embodiment of FIG. 1, the openings are approximately four inches by four inches (4″×4″) square. For a box with the dimensions illustrated in FIG. 1, there are approximately 16 openings 106 disposed in a four-by-four arrangement with sufficient material between each adjacent set of openings to support the drain board and sustain the weight of the growing media carried by the box. The cardboard box 100 is preferably made of recycled cardboard or any similar paper-based material that is strong enough to hold an amount of growing media and to break down or bio-degrade over time. Although specific dimensions are provided for a cardboard box under an embodiment, it should be noted that various different dimensions can be used, depending on the type and size of the plants to be grown, and the constraints or requirements of the building site and transportation system. When used in green roof application, the box 100 may also be referred to as a “tray” or “planter tray.”

The box 100 is configured to hold a drain board that is placed on the bottom surface and an amount of growing media that serves as the “soil” for the plants. The drainboard serves to keep the growing media in the box as the box is irrigated with water. A filter may be placed between the growing media and the drainboard to trap large particles from blocking the drainboard. FIG. 2 is a side view of a green roof system comprising a box including a drainboard and filter assembly, under an embodiment. As shown in FIG. 2, the box 200 has the drainboard 202 placed inside the box and on top surface of the bottom so that it is just over the array of drain holes 201. The filter layer 204 is placed above the drainboard 202 and the growing media 206 fills the remaining space of the box. In an embodiment, the drainboard 202 is a porous drainage core that is made of a material such as recycled polypropylene. The drainboard material can be provided in the form of entangled filaments or threads that are bonded to a fabric and molded to a specific shape or form factor that enhances water drainage. To enhance the recyclable nature of the roof planter system, a recycled material for the drainboard is used. An example drainboard product includes the Enkadrain® product by Colbond, Inc, or the garden drain G15® by American Hydrotech, Inc. It should be noted that any suitable material that provides drainage of water and is of the appropriate size and shape and preferably made from a sustainable material can be used for the drainboard 202.

The growing media 206 placed in the box 200 is generally any type of media appropriate for the plants to be grown in the box, such as ground soil, potting soil, composts, mulch, fertilized soils, and so on. In typically applications, an appropriate engineered growing media for plants can be used instead or along with soil. Such growing media can be selected in accordance with the applicable requirements of any green roof applications or standards bodies.

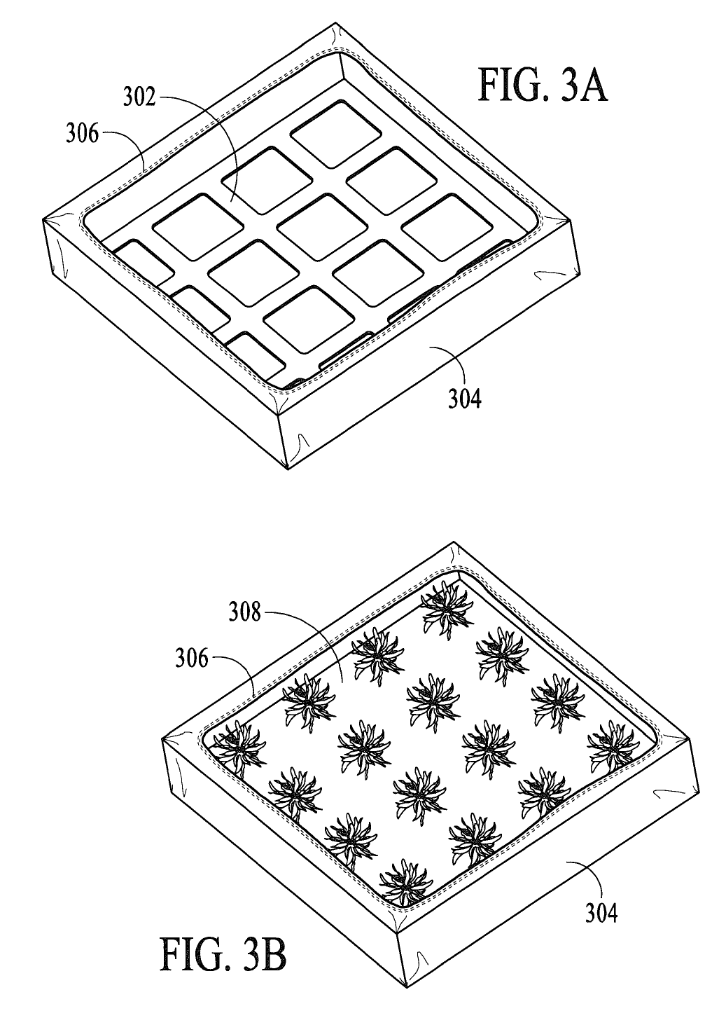

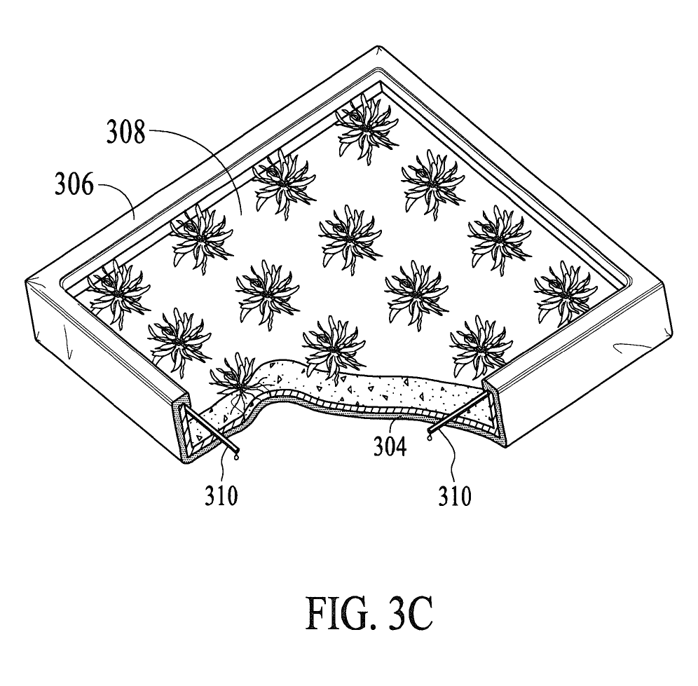

In an embodiment, the green roof box is provided with a filter fabric enclosure, in the form of a sock or sack that fits around the bottom of the box. FIG. 3A illustrates a green roof box with a filter fabric drainage enclosure, under an embodiment. A filter fabric sock 304 is placed around the bottom of box 302. The filter fabric sock is made of a recycled felt, or similar material, that has some degree of porosity to allow water drainage from the bottom of the box through the box drain holes. The filter fabric sock 304 includes an elastic band 306 that holds the wraps the sock fabric over the edge of the box and holds it tight against the box. The use of a filter fabric sock is in addition to the drain board placed at the bottom of the box 302, and together they facilitate the drainage function while providing an opportunity for the plant roots to be contained within the structure of the modular box. Once the filter fabric sock is placed around the box, the box can be filled with growing media and vegetation. FIG. 3B illustrates the encapsulated green box of FIG. 3A as filled with growing media and plants. As shown in FIG. 3B, the growing media 308 is filled to a level just below the elastic banded portion 306 of the filter fabric 304. The plants can then grow through the open top of the box 302.

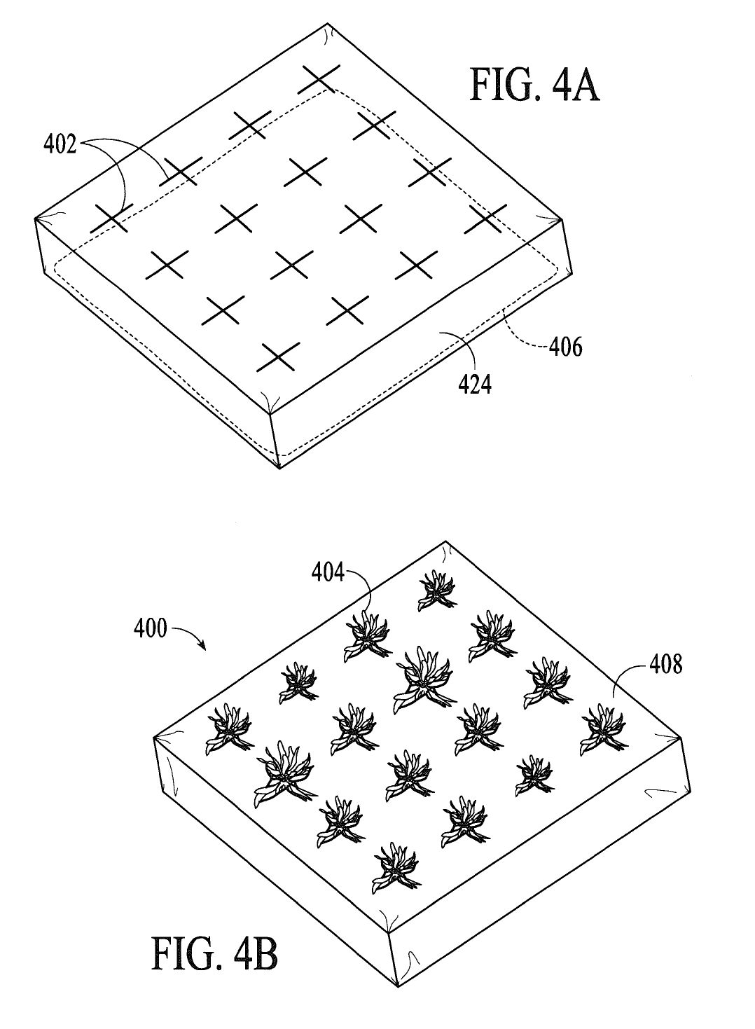

In an alternative embodiment, a filter fabric cap is provided to fit over the box to provide protection to the top surface of the box and the growing media when it is deployed on the building. FIG. 4A illustrates a filter fabric cap that can be used in conjunction with the box in a green roof system, under an embodiment. The filter fabric cap 424 comprises a piece of felt or similar filter material (preferably recycled) that is cut to a size that conforms to the dimension of the box, such as 16″×16″×4″. The material of the fabric cap is typically on the order of 1/16 to ⅛ inches thick, but may vary, and is generally selected to facilitate water permeability and growth of the plants through the fabric. The fabric cap is formed into a shape that enables the cap to fit closely over the box and growing media layer. The top surface includes a number of punched holes 402 that facilitate the growth of the plants therethrough. The filter fabric cap is formed such that it fits around the entire top and sides of the box. The bottom is left uncovered to allow water drainage through the openings in the bottom of the box and the drain board at the bottom of the box. The bottom hem of the cap can include an elastic band 406 to allow a form-fit of the cap onto the box. FIG. 4B illustrates a modular green roof box with a fabric cap and growing plants, under an embodiment. As shown in FIG. 4B, box 400 is covered by filter fabric cap 408 with plants 404 growing through the openings in the filter fabric. A number of such boxes can be placed side-by-side in an array on a roof or building surface to form a green roof system, however a separate filter fabric layer would be placed on the roof surface in preparation for the placement of the modular pre-vegetated planters with the filter fabric cap only.

Instead of a fabric cap, such as that shown in FIG. 4B, the green roof box can be packaged within a felt pillow material. Such a pillow would encapsulate the entire box in form fitted sack that can be tightly or loosely bound around the box. The pillow material would be made of felt or other similar porous material to facilitate water permeability and drainage through the bottom of the box. The pillow encasement may be elasticized along a top portion (such as shown in FIG. 3A) to hold it in place around the box. In this application, the growing media and plants would be fully exposed.

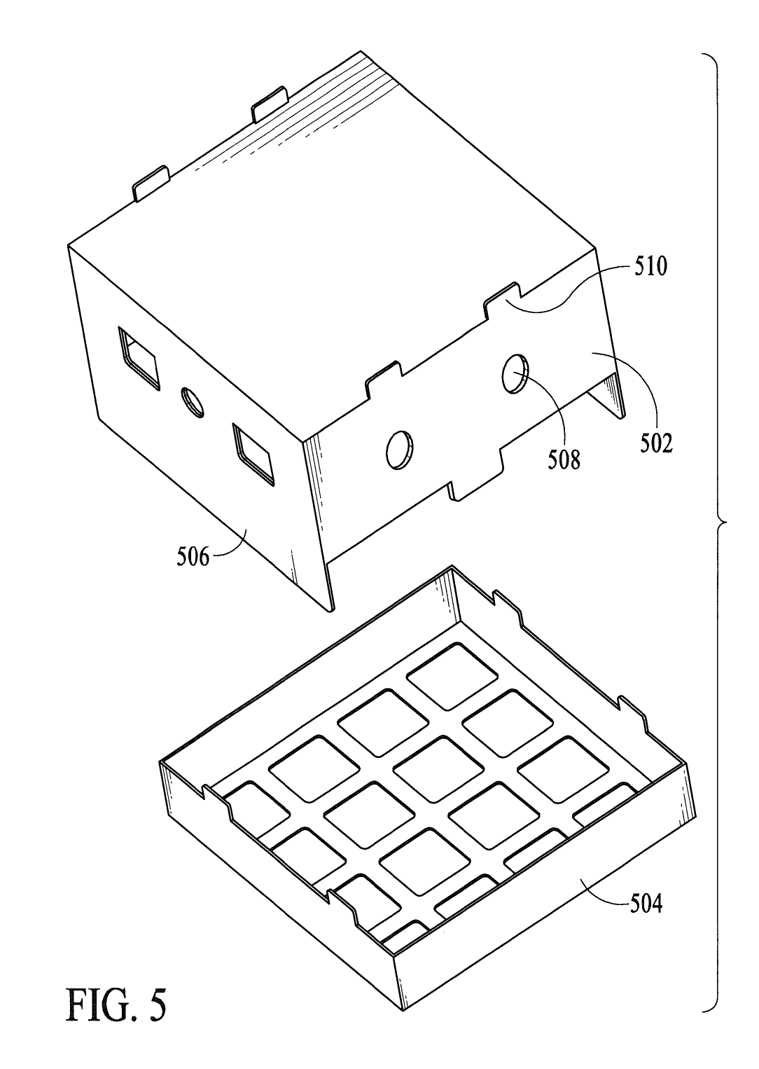

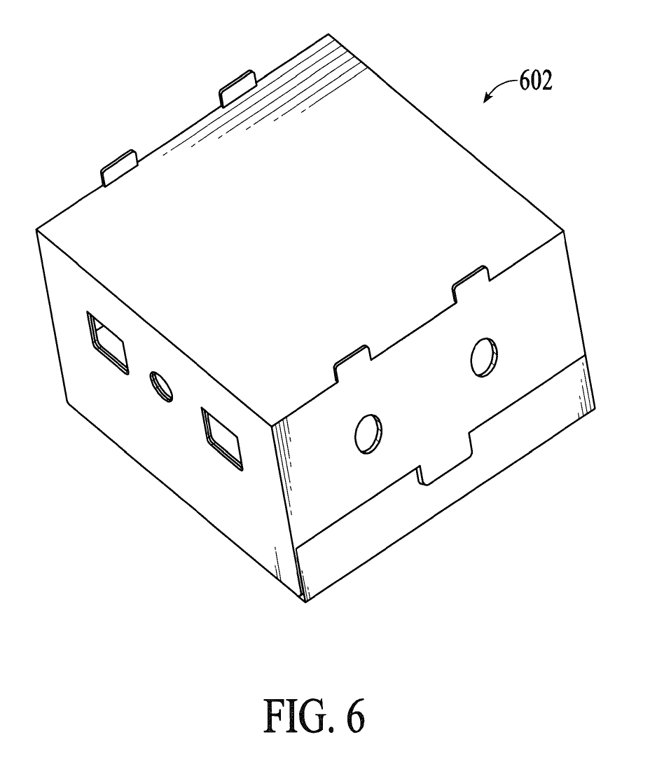

In an embodiment, the green roof box includes a fitted lid that covers the growing media and any growing plants during transport of the box to the installation site. The fitted lid is preferably made of the same material as the box, i.e., recycled cardboard or other biodegradable paper material. FIG. 5 illustrates a green roof box and lid, under an embodiment. As shown in FIG. 5, the lid 502 is formed into an appropriate shape and size to fit over the box 504. The box lid includes downward facing tabs 506 on at least two of the sides that are configured to fit inside the box 504. The height of the tabs 506 is the same as the height of the box 504 (e.g., 4″) so that the lid rests on top of the box using both the tabs and the sides of the lid as support on the box 504. The overall height of the lid 502 is generally variable and is selected to allow a volume of space and air over the top of the growing media and any growing plants. If the box is transported with no growing plants and growing media or pre-seeded growing media only, a relatively low profile lid (e.g., 1″ tall) can be provided. If growing plants are present, or are anticipated to grow during storage or transport, than a higher profile lid (e.g., 4″ to 7″ tall) can be provided, depending on the type of plants and duration of transport/storage. The lid can also be provided with a plurality of holes 508 to allow the passage of air to the plants and growing media when the lid is attached to the box. FIG. 6 illustrates the green roof box and lid of FIG. 5 with the lid fitted over the box. As can be seen in FIG. 6, the completed box/lid assembly 602 comprises an integrated storage and transport system for the green roof box.

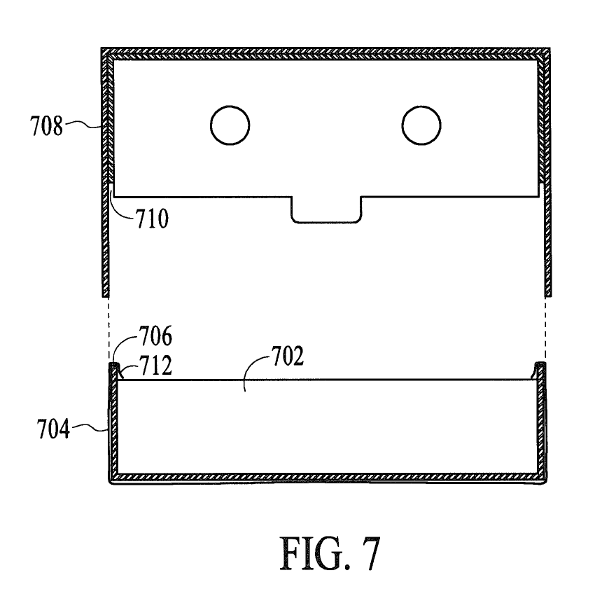

For the embodiment of FIG. 3A in which the roof box is provided with a filter fabric enclosure that fits around the bottom of the box, a matching tab/slot system is used to hold the filter fabric in place when the box and lid are enclosed. FIG. 7 illustrates the locking of the filter fabric enclosure by a box/lid pair, under an embodiment. As shown in FIG. 7, the filter fabric sock 704 is wrapped over a nesting tab 706 that protrudes above the walls of the box 702. An elastic band 712 is used to hold the filter fabric tight against the nesting tabs. The nesting tabs are configured to be inserted into matching nesting slots 710 of lid 708 when the lid is installed on the top of box 702. This effectively locks the filter fabric around the box 702 and facilitates transport of the box.

In an embodiment, the box/lid assembly is configured to optimize the transport of a large number of boxes to a building site to facilitate the installation of a green roof on a relatively large building or structure. In this case, the components of the green roof system comprise the box, the drainage board, the optional filter, pre-seeded growing media and any additional vegetation, lid and fabric sock or cap. The components are typically provided in a kit form to allow construction either at the construction site or for pre-assembly away from the construction site. In a typical application, a number of boxes will be assembled away from the construction site and transported to the site for easy installation at the building. The boxes comprise a modular green roof system in which pre-vegetated boxes are assembled and simply taken to a site for placement on the building. A green roof of virtually any size and shape can be installed on a building by placing an appropriate number of boxes in the desired configuration. The box assemblies are configured to be transported using standard pallet (or skid) based transportation system. In general, a pallet is a flat wooden structure that supports goods and can be lifted by forklift, pallet jack, front loader, or similar jacking device. A standard pallet is typically on the order of 48 inches by 40 inches, or a similar size. The size and shape of the individual green boxes can be configured to optimize the stacking of a number of boxes on a pallet depending on the size and constraints of the transportation system. In an embodiment the green boxes are configured to be stacked onto pallets in an array of four by four boxes stacked three to four boxes high. However, any appropriate stacking configuration can be used.

In an embodiment, the box and lid assembly is configured to facilitate the stacking and placement of boxes during the transport process. As shown in FIG. 5, the top of the lid 502 includes a number of upward protruding tabs 510. The bottom surface of each box 504 has a corresponding slot. This allows boxes to be placed onto a lower lidded box such that the tabs of the lower lid fit into the slots of the box above. This locks a stacked set of box assemblies together in the vertical dimension. A set of side tabs and slots can likewise be used to lock adjacent set of box assemblies together.

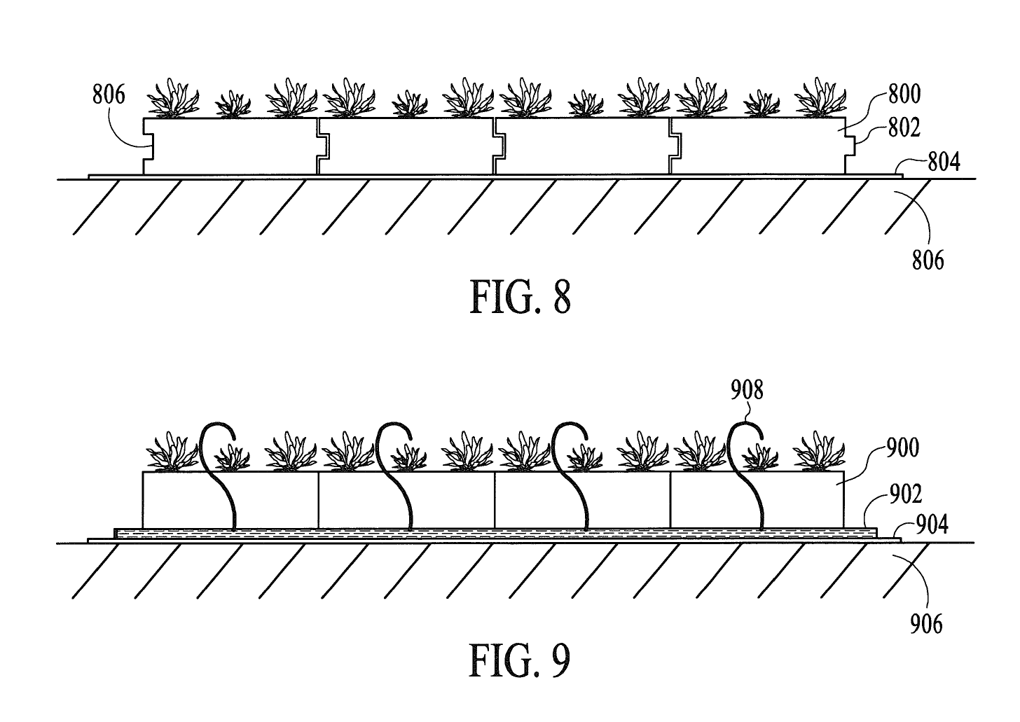

The green roof box is configured to be installed on a roof or similar surface such that a number of boxes are placed adjacent to one another in a row or an array. In an embodiment, the green roof boxes are configured to be placed adjacent to one another in close contact to prevent slippage. Depending on the size and weight of the boxes, this should be sufficient to allow the boxes to be placed in an array on a roof that is flat or has an inclination up to about a 3:12 roof slope. In an alternative embodiment, each box includes an interlocking side tab structure that allows neighboring boxes to be linked together. This mechanism further prevents slippage of boxes relative to one another when placed on a sloped surface or on a surface that is subject to high winds. FIG. 8 illustrates the installation of a green roof system on a roof, under an embodiment. In a typical installation, as shown in FIG. 8, a number of boxes 800 are placed on a horizontal, near-horizontal, or slightly pitched roof 806 of a building. The boxes are typically placed on a root barrier 804 or green roof membrane. Such a layer 804 is configured to provide a water proof layer to the roof to prevent water damage and root intrusion into the surface of the roof. Typically a heavy rubber, plastic, or similar impermeable material is used of an appropriate size and thickness to provide protection. The boxes 800 include side tabs 802 and matching slots 806 to facilitate the interlocking of adjacent boxes on the roof. In a square or rectangular array of a number of boxes, this interlocking feature prevents the boxes from sliding or moving along the surface of the roof. For an embodiment in which a fabric cap is used over the boxes during installation and deployment on the roof, the fabric cap may cover the sides of the boxes and block the side tabs. In this case, the fabric cap can incorporate the locking mechanism. In an embodiment, this can include Velcro or snap fasteners incorporated in the fabric cap to allow linking of adjacent capped boxes to one another.

As stated previously, the box 102 used in the green roof system is made of recycled cardboard or similar paper material. The material is selected so that it degrades over time when subject to plant growth within the box and normal environmental conditions. The green roof system is designed so that the boxes eventually biodegrade to allow the plants in the boxes to form an integrated field. The green roof system thus incorporates the concept of having the container material become an environment suitable for harboring the root systems of the plants and allowing these root systems to interlock among themselves as the plants grow and the roof ages. In this manner, the living system of the plants strengthens as the cardboard boxes decompose, and eventually the plants form an integrated part of the roof.

In an embodiment, the green roof system includes an integrated irrigation system to facilitate the efficient irrigation of all of the boxes in the system. Each individual box includes an irrigation tube similar water flow mechanism. The irrigation tube of each box is configured to be coupled to a central irrigation source for the distribution of water. FIG. 9 illustrates a green roof box system incorporating an irrigation subsystem, under an embodiment. For the embodiment of FIG. 9, a flat water distribution hose 902 is laid over the root barrier layer 904 on roof surface 906. Individual drip lines 908 feed water from hose 902 into the boxes 900. The boxes 900 may include a clip or groove structure in one of the walls to accommodate the individual drip line 908. In an alternative embodiment, the distribution hose 902 may be a porous hose that over the top surface of the boxes 900 to provide water directly onto the boxes. FIG. 9 illustrates a green roof system in which the individual boxes have flat plain sides and are placed in close contact next to one another to prevent slippage from side-to-side through this contact placement.

The drip line irrigation system can also be incorporated into a green roof box that includes a filter fabric sock or cap. FIG. 3C illustrates the encapsulated green box of FIG. 3B with an integrated irrigation system, under an embodiment. As shown in FIG. 3C, the box 304 holding growing media and plants 306 is encapsulated by a filter fabric held in place by elastic band 306. One or more drip lines 310 are tucked under the elastic band portion and are held in place by this band. Water flowing through lines 310 then drip onto the growing media 308 to irrigate the plants. Excess water is filtered through the bottom of the box and drains through the holes in the bottom of the box and the filter fabric enclosure.

The green roof system described herein provides a distinct advantage over existing green roof systems that utilize planters of plastic, metal, or similar non-degrading materials. These systems simply become areas where an array of planters is provided on a roof, and they do not facilitate the growth of a true integrated field of plants on a roof. Moreover, they do not facilitate the efficient transport and installation of plants or pre-vegetated grow media to a building site. These disadvantages are addressed and overcome by the green roof system described herein, in which a modular box system comprising boxes that includes a drainage board and pre-vegetated growing media are packaged in a box/lid assembly that is designed to be stackable for easy transport on pallets for placement in an interlocking array on a roof or similar surface. The use of biodegradable cardboard allows for the eventual breakdown of the container portion of the assembly and the formation of an integrated green roof of interlocking plants after a period of time after installation.

The lid assembly illustrated in FIG. 5 serves to enhance the use and deployment of the green roof system in the field and in specific projects. The lids enhance the overall sustainability of the product due to the fact that they can be recycled directly at the construction site, if necessary. Furthermore, they can help reduce return shipping costs since they do not need to be returned, unlike present tray based green roof systems.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A green roof plant growing system comprising:
a cardboard box having walls and a bottom, the bottom having a plurality of drainage holes, for placement on a building roof, wherein the cardboard is configured to biodegrade over a period of time when subject to environmental conditions on the roof and growth of plants within the box;
a drainboard placed proximate the bottom of the box;
an amount of growing media placed over the drainboard and within the walls; and
a lid configured to be placed over the box during transport of the box, the lid having a plurality of tabs protruding vertically upward and configured to insert into corresponding slots formed into the bottom of a box placed on top of the lid.

2. The system of claim 1 further comprising a fabric cap tightly fit over the box, the fabric cap comprising a permeable felt material having a plurality of holes through a top surface to accommodate the growth of plants therethrough.

3. The system of claim 1 further comprising a filter fabric enclosure fit around the bottom of the box, and including an elastic band to hold the fabric around a top surface of the box, the fabric comprising a felt material configured to facilitate plant root penetration after bio-degradation of the cardboard box.

4. The system of claim 3 wherein the filter fabric enclosure is attached to nesting tabs on an opposite pair of walls of the box by the elastic band, and wherein the nesting tabs are configured to fit into corresponding nesting slots in the lid to lock the fabric filter enclosure onto the box when the lid is fitted onto the box.

5. The system of claim 1 further comprising an integrated irrigation tube coupled to at least one wall of the box to allow the flow of water into the growing media.

6. The system of claim 1 wherein growing media is pre-seeded with plant seeds.

7. The system of claim 1 wherein the growing media is pre-vegetated plant seedlings or plugs.

8. The system of claim 1 wherein the walls of the box further comprise a plurality of slots and tabs configured to allow an interlocking of adjacent boxes when placed immediately proximate one another in a row.

9. A box for use in a green roof plant growing system comprising:
a plurality of walls;
a bottom section coupled to the walls, the bottom having a plurality of drainage holes, for placement on a building roof, wherein walls and the bottom are made of a paper material that is configured to biodegrade over a period of time when subject to environmental conditions on the roof and growth of plants within the box;
a drainboard placed proximate the bottom section;
an amount of growing media placed over the drainboard and within the walls; and
a lid configured to be placed over the box during transport of the box, the lid having a plurality of tabs protruding vertically upward and configured to insert into corresponding slots formed into the bottom of a box placed on top of the lid.

10. The box of claim 10 further comprising a fabric cap tightly fit over the box, the fabric cap comprising a permeable felt material having a plurality of holes through a top surface to accommodate the growth of plants therethrough.

11. The box of claim 9 further comprising a fabric filter enclosure fit around the bottom of the box, attached to nesting tabs on an opposite pair of walls of the box by an elastic band, wherein the nesting tabs are configured to fit into corresponding nesting slots in the lid to lock the fabric filter enclosure onto the box when the lid is fitted onto the box.

12. The box of claim 9 further comprising an integrated irrigation tube coupled to at least one wall of the box to allow the flow of water into the growing media.

13. The box of claim 9 wherein growing media is pre-seeded with plant seeds.

14. The box of claim 9 wherein the growing media is pre-vegetated plant seedlings or plugs.

15. The box of claim 9 wherein the walls of the box further comprise a plurality of slots and tabs configured to allow an interlocking of adjacent boxes when placed immediately proximate one another in a row.
